(19) United States
(12) Patent Application Publication
(10) Pub. No.: US 2019/0089808 A1
(43) Pub. Date: Mar. 21, 2019

(54) USER PREFERENCE ASSIGNMENT USING NFC TAGS IN HOSPITALITY APPLICATIONS

(71) Applicant: CARRIER CORPORATION, Jupiter, FL (US)

(72) Inventors: Amuduri Santhosh, Hyderabad (IN); Adam Kuenzi, Silverton, OR (US)

(21) Appl. No.: 15/814,058

(22) Filed: Nov. 15, 2017

(30) Foreign Application Priority Data
Sep. 20, 2017 (IN) 201711033282

(51) Int. Cl. H04L 29/08; H04W 4/04; G06Q 10/02; H04W 12/06

(52) U.S. Cl. CPC H04L 67/306; H04L 67/32; G06Q 50/10; G06Q 10/02; H04W 12/06; H04W 4/04

(57) ABSTRACT

A method of applying a user preference for a requested service in a building space. The method includes assigning at least one user preference associated with a desired service to a unique identifier, and transmitting the at least one user preference to at least one of a controller associated with a building system and a cloud computing environment associated with the building system. The method also includes generating a services request, the services request generated by a user indicating a desire to request the service by tapping the user device to a communication device in the building system associated with the unique identifier, and initiating the services requested based on the at least one user preference associated with the unique identifier.

### TECHNICAL FIELD

Embodiments relate generally to the assignment of user defined preferences for services in a hospitality space. More particularly, to registration and identification of a user and synchronization of user actions with predefined preferences to quickly select or obtain predefined services at a particular location.

### DESCRIPTION OF RELATED ART

In the hospitality industry, enhancing customer satisfaction is a priority. Faced with increased industry competition, many hotel operators are looking for smarter ways to maximize customer satisfaction, improve customer services, and generate more revenue from their properties. Expanding how hotel customers access available services has proven to be a successful strategy for many hotels. Such services may include reserving a room, reserving a taxi, reserving a conference room, selecting from digital content available via a television, reserving a game room or game console, making a spa appointment, ordering food, making travel reservations, reserving a hospitality suite, requesting room service, or a combination thereof.

By way of a non-limiting example, electronic devices such as televisions, computers, user mobile devices, tablets, and the like play an important role in providing interfaces and implementing services for guests. Likewise such devices facilitate providing services and generating revenues. Users are increasingly using a variety of apps on their personal mobile devices to investigate, request, pay for and receive services. However, such services may require a different app for each service requested which can become cumbersome and burdensome. To access services particularly in a hospitality environment, users may obtain access cards or interface with a service counter. In such situations, typically, users must either seek assistance from hotel administration or stand in queues to gain access to one or more services. Moreover, in order to access different services, different requirements, lines, applications and the like may be required, which can be confusing as well as inconvenient. In addition, users have no privacy when accessing services in an unfamiliar environment, and may wish to keep such records private for personal or security reasons. A further problem faced by users is that while accessing services, especially when using individual apps, kiosks and the like, users may be presented with unfamiliar menus and user interfaces when using devices provided by the facility, e.g., a hotel for accessing services, and it may be more time consuming for users to use these unfamiliar menus and user interfaces in comparison to personalized menus or favorites lists on the user's own device.

Keeping in view all of the above, it would be desirable to have an improved system and method of providing personalized services as well as provide users a means to quickly identify and request desired services in hospitality or Business-to-Business (B2B) environments.

### BRIEF SUMMARY

Described herein in an embodiment is a method of applying a user preference for a requested service in a building space including, assigning at least one user preference associated with a desired service to a unique identifier, and transmitting the at least one user preference to at least one of a controller associated with a building system and a cloud computing environment associated with the building system. The method also includes generating a services request, the services request generated by a user indicating a desire to request the service associated with the unique identifier and initiating the services requested based on the at least one user preference associated with the unique identifier.

In addition to one or more of the features described above, or as an alternative, further embodiments may include that the assigning includes executing an app on the user device configured to permit a user to preselect the desired services and assign the desired services to the unique identifier.

In addition to one or more of the features described above, or as an alternative, further embodiments may include that the assigning is independent of location and the building system.

In addition to one or more of the features described above, or as an alternative, further embodiments may include that the transmitting includes communicating the user preferences to at least one of a cloud computing environment associated with the building system, a control device associated with the building system, and an application associated with the building system executing on the user device.

In addition to one or more of the features described above, or as an alternative, further embodiments may include that the user preferences include at least one of a user setting, a schedule, and building system operational parameters.

In addition to one or more of the features described above, or as an alternative, further embodiments may include that the generating includes tapping the user device to a communication device in the building system and the user device communicating with at least one of a cloud computing environment associated with the building system and a control device associated with the building system, the communicating including the unique identifier and information associated with the building space in the building system, and wherein the building system employs the unique identifier to identify the desired services associated therewith.

In addition to one or more of the features described above, or as an alternative, further embodiments may include that the information includes the identifier for the building space in the building system that enables the building system to identify at least one of the requestor of the desired services, the room or location of the building space in the building system, and the current location of the user.

In addition to one or more of the features described above, or as an alternative, further embodiments may include that the initiating includes at least one of a cloud computing environment associated with the building system and a control device associated with the building system employing the unique identifier and information associated with the building space in the building system to identify the desired services associated therewith and request the desired services.

In addition to one or more of the features described above, or as an alternative, further embodiments may include that the building space is a hotel and the desired services include at least one of calling a taxi, a do not disturb notice, check out assistance, room service, and telephone service.

In addition to one or more of the features described above, or as an alternative, further embodiments may include providing a notification to the user via the user device regarding the requested services.

In addition to one or more of the features described above, or as an alternative, further embodiments may include that the generating includes presenting a credential for authentication.

In addition to one or more of the features described above, or as an alternative, further embodiments may include that the credential includes at least one of an identification of the user, an identification of a user device, an identification of the control device associated with the first building system, a biometric, and a password.

In addition to one or more of the features described above, or as an alternative, further embodiments may include that the initiating further includes at least one of a cloud computing environment and a control device associated with the building system authenticating the credential and communicating an indicia of authentication to the user device.

In addition to one or more of the features described above, or as an alternative, further embodiments may include that the indicia of authentication is at least one of a message, a token, a digital certificate, and a password.

In addition to one or more of the features described above, or as an alternative, further embodiments may include that the authenticating includes validating a biometric.

In addition to one or more of the features described above, or as an alternative, further embodiments may include that the cloud computing environment and controller associated with the second building system includes a local server.

In addition to one or more of the features described above, or as an alternative, further embodiments may include that the building system is at least one of a security system, access control system, and a vehicle and the control device is a lock.

Also described herein in an embodiment is a system for applying a user preference for requested services in a building system, the system including a building system having a building space associated therewith, the building system includes at least one of a controller associated with the building system and a cloud computing environment associated with the building system, the building system configured to provide an application operable on a user device to facilitate assigning of at least one user preference associated with a desired service associated with the building system to a unique identifier, the user device configured for operable communication with the at least one of the controller associated with the building system and the cloud computing environment associated with the building system, the user device executing an application. The system also includes at least one communication device in operable communication with the user device, the at least one communication device providing the unique identifier to the user device and the user device configured to communicate a request for desired services to the at least one of the controller associated with the building system and the cloud computing environment associated with the building system, the at least one of a controller associated with the building system and the cloud computing environment associated with the building system are configured to initiate the services requested based on the at least one user preference associated with the unique identifier.

Also described herein in yet another embodiment is system for applying a user preference for requested services in a building system having a building space associated therewith, the system including, means for assigning at least one user preference associated with a desired service to a unique identifier, and means for configuring a user device to transmit the at least one user preference to at least one of a controller associated with a building system and a cloud computing environment associated with the building system. The system also includes means for generating a services request, the services request generated by a user indicating a desire to request the service associated with the unique identifier and means for initiating the services requested based on the at least one user preference associated with the unique identifier.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded of the described embodiments is particularly pointed out and distinctly claimed in the claims at the conclusion of the specification. The foregoing and other features, and advantages of the described embodiments are apparent from the following detailed description taken in conjunction with the accompanying drawings in which:

FIG. 1 depicts a simplified diagrammatic view of the system and interfaces for implementing the methodology of utilizing user preferences to select a service in accordance with an embodiment;

FIG. 2 is a depiction of a cloud computing environment as may be employed in accordance with an embodiment;

FIG. 3 depicts a simplified block diagram of a computing system as may be implemented in a user device in accordance with an embodiment; and

FIG. 4 depicts a flowchart of an example method utilizing user preferences in a remote building system in accordance with an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in Figure X may be labeled “Xa” and a similar feature in Figure Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments are related to a method of applying a user preference for a requested service in a building space. The method includes the request from a user initiated from a mobile device that interacts with a communication device in the building space. Further, the communication device may be a generic door sign. Further, the user preference may be previously established by the user as a service that is associated with a particular numbered operator. Further, the door sign may have generic numbers printed on the sign with a NFC communication device associated with each number. Further, each NFC communication device may have a unique identifier. Further, the user may interact with the door sign and initiate the request for service by tapping the mobile device on the door sign next to a number and in the process the mobile device will read the unique identifier of the one or more NFC enabled communication devices. Thus the user avoids the typical need to scroll through User Interface (UI) options in order to access services of their choice on service devices such as a kiosk or wait in lines. Another feature of the described embodiments is to enable hospitality and (B2B) industries to configure service preferences for a user in advance of user arrival. Service providers or hotel administration can display available services by means of a mobile application or a hotel website. The user can configure any of the displayed services or content and associate them with a numbered operator in advance. Particular NFC communication devices can then be identified in advance as pertaining to the user's reservations and the user's pre-configured preference can be applied and downloaded to their mobile device or to the building system. Requesting services configured according to the user's preferences will allow users to feel as if they are using their own devices having personalized content even though the door sign uses generic numbered operators.

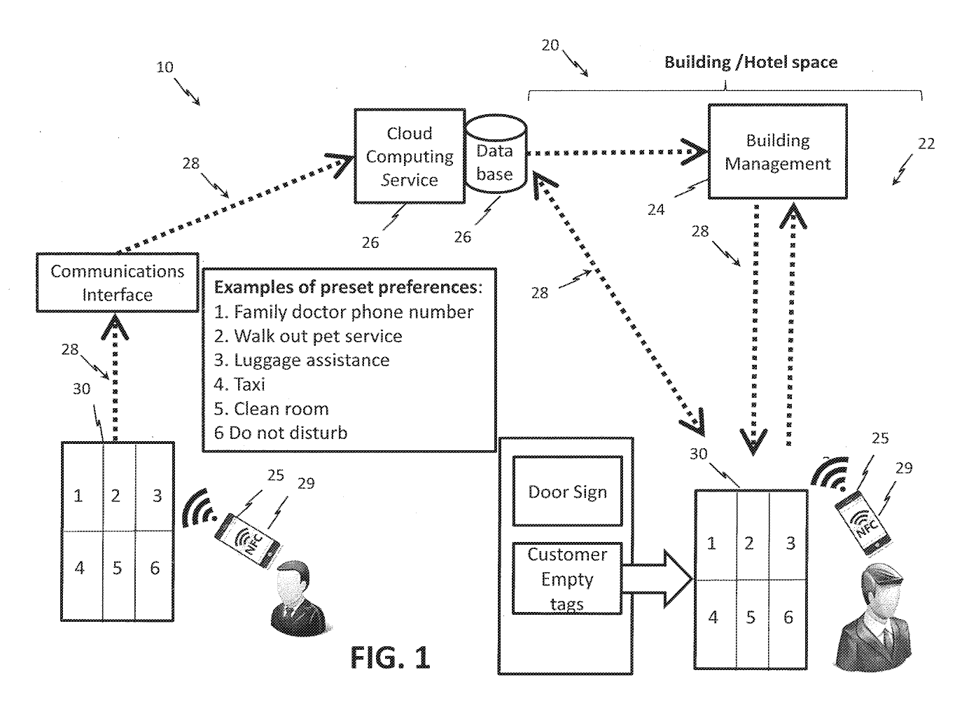

Referring now to the drawings, FIG. 1 illustrates a diagrammatic overview of a system 10 for using user preferences in a building system environment, in particular, for example, a hospitality environment. In an embodiment the system 10 includes a building system 20 associated with a first building space 22. For example, an office or room in a hotel, recreational vehicle, car, and the like. In application, this building space 22 would be one that the user employs occasionally or perhaps even only once. As can be appreciated, typically such a building space 22 would be one that a particular user may not yet have pre-established settings and preferences, such as with a building space that the user frequently visits. For example, the building space 22 may be an office space or hotel room having a security system or access control system. Each of these systems 20 may include a controller 24 that is employed to interface to the building system 22 and to control the system 20. In addition, some, or all of the functionality provided to control the building system 20 may be based on methods and processes executed remotely such as on a local or remote server or cloud computing environment 26. As will be appreciated the cloud computing environment 26 could include a local or remote server, or the system 20 and cloud computing environment 26 could be entirely remote. The building system 20 may also include a local and remote communication network and system 28 for facilitating communication and control of various features in the building system 20 as well as for facilitating communication between the user device 25, controller 24, and the server or cloud computing environment 26. Likewise, the building system 20 may also include an application (app) 29 that is operable on the user device 25, that permits and facilitates the user to enter and receive information and for user device 25 to communicate with, interface with, and control selected aspects of building system 20. In an embodiment, the app 29 may be employed by the user for example to facilitate user authentication and access permissions to the communication system 26 and permitting assignment and use of user preferences in the building space 22 (e.g. facility or room).

In an embodiment, a user employing an app 29 on the user device 25 configures a preference to a selected numbered operator, picture or icon and the like. It will be appreciated that while the embodiments herein are described with respect to selected preferences or tag 30 including or being identified by a numbered operator, that reference is for example only. Any form of distinguishing and identifying individual preferences is possible. In another embodiment, this can be accomplished by just manually identifying the tag identifier. In another embodiment the configuration is accomplished by initially tapping a selected numbered (or otherwise uniquely identified) communication device, sign, or tag 30 to establish the preset mapping to user preferences. The communication device, can be a door sign, wall sign, placemat on a table or tag on a poster, and the like. Any physical device that can include or hold the numbered operators or icons. In an embodiment the communication device is an NFC tag 30. The NFC tags each including a numbered operator or icon and a unique identifier that is communicable to a controller 24 or a user device 24.

In operation, a selected action is associated with a given communication device, e.g., NFC tag 30. Each tag 30 has a unique ID that is mapped to a numbered operator for a given location or building space 22. Advantageously, for a given operator of a building system 20, the numbered operators, icons and the like are configured to be consistent across a variety of building spaces 22, though the building system 30 and particular building space 22 may be different. In other words, once a user as established a definition for a set of preferences and associating them to a given numbered operator/icon selection, that definition will remain constant and be applicable when the user visits another room, hotel, city, and the like. The mapping is registered in a cloud computing service 26. In one embodiment, by tapping the tag 30 and reading the unique ID, and then by assigning or looking up a user preference associated with a numbered action—the user is essentially applying a preference to the number. Once the user services preferences are established, the user is able present the user device 25 and tap a selected tag 30 at the building space 22 and use the preset preferences in a variety of locations to request services.

Continuing with FIG. 1, at the building space 22, the user requests for services are made by tapping the tag 30 and reading the unique ID, and then looking up the specific user preference associated with a numbered action tag 30. The user is essentially identifying a particular numbered tag 30, the numbered tag 30 has a predefined preference associated with a given service previously assigned. When the user presents the user device 25 and taps/selects a specific tag 30 at the building space 22, the preset preferences corresponding to the specific tag 30 are identified and the request is sent to building controller 24 or the cloud computing service 26 associated with the building space 22. In an embodiment a tap on a tag 30 is a request for given previously specified services which may be set up and established a priori as described herein. Advantageously, when a user visits a different building space 22 e.g., stays in a different hotel room in a different location, a tap, e.g., selection of a given tag 30 having a previously configured identification number, in that building space 22, associated with their preferences will result in the request for those preselected or configured services being generated. Furthermore, it will be appreciated that the different tag ID will indicate to the building system 20 which actual building spaces 22 e.g., hotel and which room the user is presenting the tap on an tag 30 so that the user preferences can be intelligently applied for that building space and locale.

In an embodiment, preferences are stored in a cloud computing service 26 associated with the building system. When a user travels to a different local, and is present at a different building space 22, the preferences and selections previously established can be synced/transmitted with mobile app 29 on the user device 25. This will permit the user to review and modify as desired as well as be provided additional localized information associated with the preferences available, as well as any potential additions.

Returning to FIG. 1, in an embodiment, once the user has tapped on a selected tag 30 a request is sent to the controller 24 and/or cloud computing service 26 of the building system 22. The request is addressed and the services are provided. Advantageously, because the services requests are integrated with the controller 24 and/or cloud computing service 26 of the building system 22, billing and notifications can be provided as feedback to the user via the user device 25. For example, if preference for number #2 is to call a taxi, and the user taps preference tag #2 in the building space 22. Likewise, if preference for number #3 is to “clean room” and the user taps preference tag #3 in the building space 22, a notification may then be provided to staff from the building system 20 that the particular building space 22, e.g., room is ready and available to be cleaned The unique tag ID will indicate in the request to the controller 24 and/or cloud computing service 26 of the building system 22 that the user tapped tag #2 to request the taxi for that given building and they are staying in that given room. So a mapping can be made from a unique tag ID to a specific building system 20 e.g., a specific building and a specific building space 22, e.g., room and preference. Thus, a notification may then be provided to indicate that the taxi is coming to Hotel X for Room number Y at a particular location for a particular person (the user that made the request).

Cloud computing is a widely adopted and evolving concept. Generally, cloud computing refers to a model for enabling ubiquitous, convenient, and on-demand access via Internet to shared pools of configurable computing resources such as networks, servers, storages, applications, functionalities, and the like. There are a number of benefits associated with cloud computing for both the providers of the computing resources and their customers. For example, customers may develop and deploy various business applications on a cloud infrastructure supplied by a cloud provider without the cost and complexity to procure and manage the hardware and software necessary to execute the applications. The customers do not need to manage or control the underlying cloud infrastructure, e.g., including network, servers, operating systems, storage, etc., but still have control over the deployed applications. On the other hand, the provider's computing resources are available to provide multiple customers with different physical and virtual resources dynamically assigned and reassigned according to clients' load. Further, cloud resources and applications are accessible via the Internet.

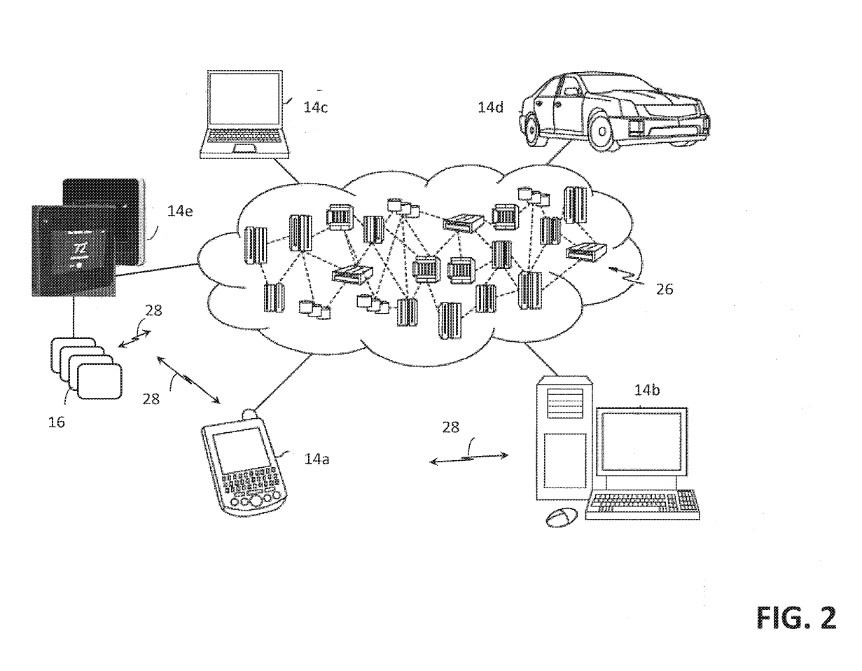

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. A cloud computing environment is service oriented with a focus on statelessness, low coupling, modularity, and semantic interoperability. At the heart of cloud computing is an infrastructure comprising a network of interconnected nodes. Referring now to FIG. 2, an illustrative cloud computing environment 26 is depicted. As shown, cloud computing environment includes one or more cloud computing nodes, such as nodes 26 (FIG. 1), with which computing devices and controllers 14a-e may communicate. Cloud computing nodes 26 may communicate with one another and/or be grouped (not shown) physically or virtually, in one or more networks, such as Private, Community, Public, or Hybrid clouds, or in one or more combinations thereof. This allows cloud computing environment to offer infrastructure, platforms and/or software as services for which a cloud consumer does not need to maintain or minimize resources at a local computing device level. It is understood that the types of computing devices 14 shown in FIG. 2 are intended to be illustrative only and that computing nodes such as 26 and cloud computing environment can communicate with any type of computerized device over any type of network and/or network addressable connection (e.g., using a web browser).

The computing devices 14a-e such as user device 25 may be any form of a mobile device (e.g., smart phone, smart watch, wearable technology, laptop, tablet, etc.). The user device 25 can include several types of devices, in one instance, even a fixed device, e.g. a keypad/touch screen affixed to a wall in a building corridor/lobby, such as building system controllers 24. In other words, the controller 24 and the user device 25 can all be computing devices 14a-e. It should be appreciated that the system controllers 24 are typically part of the installed building system infrastructure, while the third user device 25 is typically owned and used by the user, service man, homeowner, and the like. The term “user device” 25 is used to denote all of these types of devices as may be employed by the user for the purposes of communication with the building system 20. It should be appreciated that in some instances a user device 25 or the controller 24 are proximate to the system(s) 20, for example, a thermostat or system control unit, in others they are mobile for example, a car, PDA, or movable kiosk. For example, in an embodiment, the computing devices could be, a personal digital assistant (PDA) or cellular telephone tablet 14a, such as user device 25, desktop computer/terminal/server 14b, laptop computer 14c, a vehicle 14d, or a security or access control panel/HVAC thermostat 14e, such as controller 24. Computing devices 14a-e may also be configured to communicate with each other or a variety of sensors 16. The communication with other computing devices 14a-e or sensors 16 could be wired or wireless as needed. The computing devices 14a-e are generally connected to and with a communication network, such as communication network 28 such as local area network (LAN), wide area network (WAN) or cellular, and the like, to facilitate communication with and between computing devices or controllers 14a-e and the cloud computing nodes 26 as will be described further below.

The computing devices, 14a-e such as user device 25, as well as other components of the system 20 including building system controller 24 can communicate with one another, in accordance with the embodiments of the present disclosure, e.g., as shown in FIG. 1. For example, one or more user devices 25 and controller 24 may communicate with one another when proximate to one another (e.g., within a threshold distance). The user device 25 and controller 24 may communicate over one or more networks 28, (e.g., a communication bus) that may be wired or wireless. Wireless communication networks can include, but are not limited to, Wi-Fi, short-range radio (e.g., Bluetooth®), near-field infrared, cellular network, etc. In some embodiments, controller 24 may include, or be associated with (e.g., communicatively coupled to) one or more other networked building elements (not shown), such as computers, beacons, other system controllers, bridges, routers, network nodes, etc. The networked elements may also communicate directly or indirectly with the user devices 25 using one or more communication protocols or standards (e.g., through the network 28). For example, the networked element may communicate with the user device 25 using near-field communications (NFC) and thus enable communication between the user device 25 and building system control unit 24, or any other components in the system 10 when in close proximity to the user device 25 (NFC is a short range wireless protocol). Or, for example, the networked element may communicate with the user device 25 using Bluetooth and thus enable communication between the user device 25 and building system control unit 24 or any other components in the system 10 from a further distance. The network 28 may be any type of known communication network including, but not limited to, a wide area network (WAN), a local area network (LAN), a global network (e.g. Internet), a virtual private network (VPN), a cloud network, and an intranet. The network 28 may be implemented using a wireless network or any kind of physical network implementation known in the art. The user devices 25 and/or the computing devices may be coupled to the controller 24, through multiple networks (e.g., cellular and Internet) so that not all user devices 25 and/or the computing devices are coupled to the any given controller 24 or component through the same network 28. One or more of the user devices 25 and the controller 24 may be connected in a wireless fashion. In one non-limiting embodiment, the network 28 is the Internet and one or more of the user devices 25 executes a user interface application (e.g. a web browser, mobile app) to contact and communicate with the system's controller 24, through the network 28.

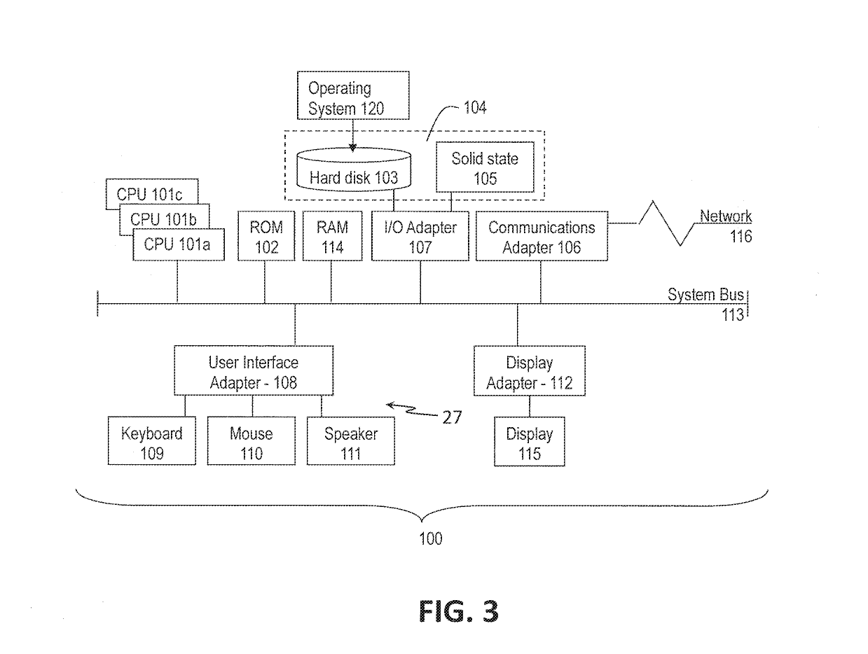

Referring to FIG. 3, the computing devices 14a-e, including user device 25 and controller 24, may include a processing system including a processor, memory, and communication module(s), as needed to facilitate operation and interfacing with various components and elements of the building system(s) 20. In one embodiment, the computing devices 14a-e, including user device 25 and controllers 24 each may include a computing system 100 having a computer program stored on nonvolatile memory to execute instructions via a microprocessor related to aspects of communicating and controlling a building system(s) 20 and in particular executing a method for utilizing user preferences for requesting services in the building system 20 as described further herein.

In an embodiment, the computing system 100 has one or more processing units (processors) 101a, 101b, 101c, etc. (collectively or generically referred to as processor(s) 101). The processor 101 can be any type or combination of computer processors, such as a microprocessor, microcontroller, digital signal processor, application specific integrated circuit, programmable logic device, and/or field programmable gate array. As is conventionally done, the processors 101 are coupled to system memory 114 and various other components via a system bus 113. The memory can be a non-transitory computer readable storage medium tangibly embodied in the user including executable instructions stored therein, for instance, as firmware. Read only memory (ROM) 102 is coupled to the system bus 113 and may include a basic operating system, which controls certain basic functions of system 100. Random Access Memory (RAM) 114 is also coupled to the system bus 113 and may include a basic storage space to facilitate program execution.

FIG. 3 further depicts an input/output (I/O) adapter 107 and a network adapter 106 coupled to the system bus 113. I/O adapter 107 communicates with hard disk 103 and/or solid state storage 105 or any other similar component. I/O adapter 107, hard disk 103, and solid state storage 105 are collectively referred to herein as mass storage 104. As is conventionally done an operating system 120 for execution on the processing system 100 may be stored in mass storage 104. A network adapter 106 interconnects bus 113 with an outside network 116 such as and including communications network 28 and the like, enabling computing system 100 to communicate with other such systems. The network adapter 106 may implement one or more communication protocols as described in further detail herein, and may include features to enable wired or wireless communication with external and/or remote devices separate from the user device 25. The computing device 14a-e including the user device 25 and controller 24 may further include a user interface, shown generally as 27, e.g., a display screen, a microphone, speakers, input elements such as a keyboard 109 or touch screen, etc. as shown in FIG. 3) as known in the art. A screen (e.g., a display monitor) 115 is connected to system bus 113 by display adaptor 112, which may include a graphics adapter and a video controller. A keyboard 109, mouse 110, and speaker 111 all interconnected to bus 113 via user interface adapter 108. It should be appreciated that in some embodiments some or all of these elements of the computing system 100 may be integrated. In one embodiment, adapters 107, 106, and 112 may be connected to one or more I/O busses that are connected to system bus 113 via an intermediate bus bridge (not shown). Suitable I/O buses for connecting peripheral devices may also be employed Additional input/output devices are shown as connected to system bus 113 via user interface adapter 108 and display adapter 112. It should be appreciate that the components of the system as described are for illustration purposes only. Features and functions as described may be omitted, integrated, or distributed as desired and as required to suit a particular application.

Embodiments provided herein are directed to apparatuses, systems, and methods for making and fulfilling requests for services or more specifically applying a set of previously established user preferences substantially uniformly across variety of buildings. In some embodiments, establishing the preferences, the request for services, (herein after simply a request), and notifications may be communicated over one or more lines, connections, or networks, such as network 28, e.g., a request made by a user device 25 and transmitted through the network 28 to a cloud environment 26 or controller 24, and the like. The request may be initiated by a mobile device controlled by and/or associated with a user, e.g., user device 25 in a passive or active manner. In some embodiments, the mobile device may be operative in conjunction with a Transmission Control Protocol (TCP) and/or a User Datagram Protocol (UDP). In some embodiments, a request may be authenticated or validated based on a location and/or identification of the user device 25. For example if the user device 25 has been registered and preauthorized. Moreover, in some embodiments, a request may be fulfilled in accordance with one or more profiles, such as one or more user or mobile device profiles. In some embodiments the profiles may be registered as part of a registration process. In some embodiments, a building system may be registered with a service provider.

As noted, the controller 24 may be associated with a building system (e.g., building system 20). The controller 24 and/or the cloud computing environment 26 may be used to process or fulfill the requests that are submitted from one or more user devices 25. The requests may be received through the network 28 from the one or more user devices 25 and/or the networked building elements such as other controllers or control devices e.g., 14a-e, which may be mobile devices, including, but not limited to phones, laptops, tablets, smartwatches, etc. As stated earlier, one or more of the user devices 25 may be associated with (e.g., owned by) a particular user with the building system 20 identifying the user based on the registration with the app 29 on the user device 25 and the preferences as established by the user.

For example, a user of a user device 25 may request service in an affirmative or active manner. The user may enter a request by tapping a tag 30 as described herein or using an I/O interface of the user device 25, as described herein. That is, in some embodiments, an application, (app) 29, or other program may be installed and operated on the user device 25 wherein the user may interact with the app or program to initiate or facilitate a request.

In other embodiments, or in combination therewith, the user may initiate a request in a passive manner. For example, a profile may be established for the user or the particular user device 25, optionally as part of a registration process with, e.g., a service provider and/or through historical data tracking. The profile may contain a log of the user's history and/or activities, such as where the user has gone or traveled to, the user's preferences, or any other data that may be applicable to the user. In some embodiments, the user profile and preferences may be accessed or analyzed to infer information regarding the user and/or the request. Resources may be provisioned or allocated to fulfill the request as needed. The request for service may be conveyed or transmitted from the user device 25 through the network 28. For example, the request may be transmitted to and/or over the Internet and/or a cellular network. The network 28 may include infrastructure that may be organized to facilitate cloud computing as described above. For example, one or more servers, such as a primary message server, a backup message server, and a device commissioning message server may be employed as part of the network 28.

In some embodiments, the request may specify details regarding the type of service requested, at any level of detail or abstraction. For example, a first request may specify that service is requested, a second request may specify additional information requesting authentication, and a third request may specify additional parameters or constraints associated with the request. For example, in some embodiments, the request may include an identifier associated with the user or the particular user device 25 in order to allow a controller 24, and or the cloud computing environment 26, to distinguish between users and/or user devices 25.

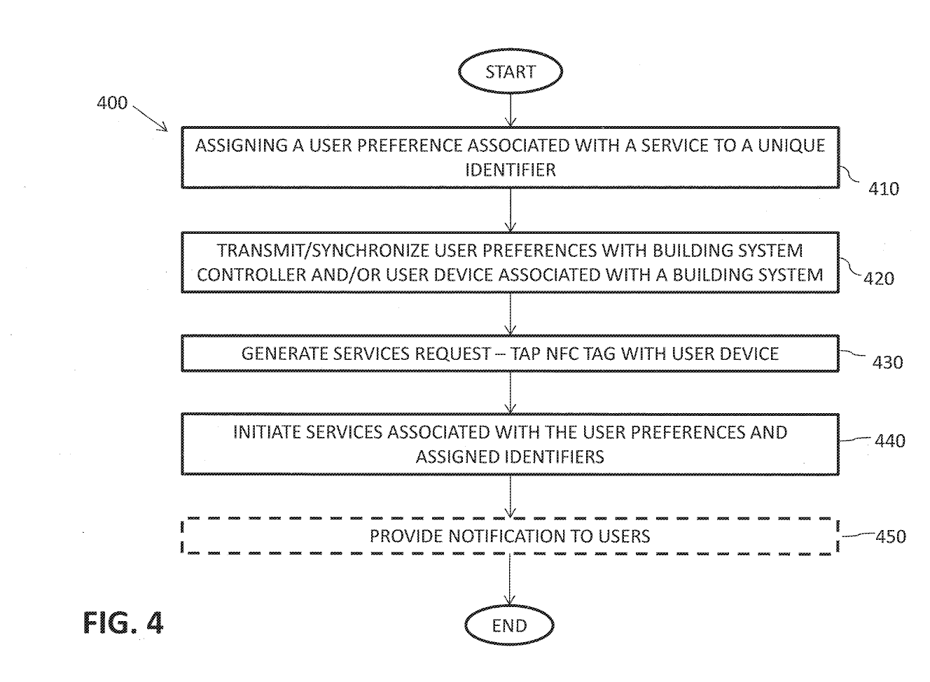

Referring to FIG. 1 once again, and turning now to FIG. 4 for a description of the methodology of defining and applying a user preferences for services in a building space 22. FIG. 4 is a flowchart depicting an example high level method 400 for utilizing user preferences to request services in a remote building system in accordance with an embodiment. In an embodiment, the method begins with assigning a user preference associated with a service to a unique identifier as depicted at process step 410. Of course, it should be appreciated that each unique identifier associate with a tag 30 shall have at least one user preference so that a guest can at least select on preference for a given tag 30. Likewise a particular tag could be associated with multiple preferences and thereby a user could select multiple preferences with a selection of a single tag 30. In an embodiment the user preference is assigned to a NFC tag 30 having a unique identifier that is recognizable by a controller 24 or cloud computing environment 26 in a building system 20. In an embodiment, the preferences associated with building system 20 are stored in the cloud computing environment 26 and may also be stored in the user device 25. In another embodiment, the preferences could be passed from the cloud computing environment 26 to another cloud computing environment 26, or to the controller 24 as described herein.

Continuing with FIG. 4 and the method 400, at process step 420 the method 400 includes transmitting/synchronizing user preferences to building system controller 24 associated with a building system 20 and/or user device 25 when at the building space 22. In an embodiment, the app 29 on the user device 25 may be configured to communicate with the controller 24 associated with the building system 20 or the cloud computing environment 26 to provide/synchronize the preselected user preferences and their mapping to the NFC tags 30. In one embodiment the controller 24 is a controllable device 14a-14e (FIG. 2) for the building system 20 and the access is via a local communication interface 28. In another embodiment the controller 24 is a server or cloud computing network 26 as described earlier. In another embodiment, the user device also requests authorization for communication in the building system 20. The app 29 may communicate with the controller 24 and/or the cloud computing environment 26 to request and obtain such authorization. In another embodiment the authorization may be through another computing device 14a-e such associated with another building system such as a room lock. It will be appreciated that a user device executing the app 29 associated with the building system 20 may include such authorization to ensure identification of the user and user device 25. In some embodiments the authorization includes a request for access (whether physical or via communications) to the building system 20 by presentation of a form of credential. For example, via the app on the user device 25 where the user device 25 is preregistered with the second building system 30. Such a request may be via an app on the user device 25, or the cloud computing environment 26 associated with the building system 20. In some embodiments, the authorizing includes validating the request for access and providing access or an authorization for the communication. In another embodiment the authorizing includes a validation of the request for access and providing a token to facilitate further authenticated communications. In some embodiments the authorization and/or token is provided to the user device 25, in other embodiments the authorization/token is provided to a component of the first building system 20. In some embodiments, other techniques could be employed for authentication. For example, biometrics may be employed as a means of authenticating to the second building space 30. This could be done by a thumbprint reading on the sensor on the user device 25 relayed to the other cloud computing environment 26 or a sensor (not shown) receiving a biometric associated with a credential shared, i.e., a biometric profile or reference to a profile). The biometric could be a thumbprint or a picture of a person taken by a camera (phone's camera or other) or a voice recognition, and the like.

In some embodiments the request may include a user biometric (voice, face, thumbprint) as an example credential presented with the request. In an embodiment the user biometric is retrieved by the user device 25 and is validated before sending the request and credential to the second building system 20. For example a picture for thumbprint verified for access to the user device 25. In another embodiment a user biometric is retrieved by the user device 25 and is sent along with the request and credential and is validated/authenticated by the second building system 20. For example, the biometric could be a picture that is sent with the request, the picture is then observed or compared to a picture on file for the part of the authentication. Finally, in another embodiment, the credential is sent along with the request to the second building system which then utilizes a biometric device (not shown) to read a biometric and validate that the requester is authentic.

Continuing with FIGS. 1 & 4 and the method 400, at process step 430 the method 400 includes the user generating a request for a service. In an embodiment the request for service is initiated by the user tapping a door sign and reading one or more of the NFC cards/tags 30 that include unique identifiers with the user device. The indication of a request along with the unique identifier is then transmitted to the controller 24 or cloud computing environment 26 using the communications network to the controller where the particular services that have been previously associated with the particular tag 30 are then ordered as depicted at process step 440. Finally, optionally at process step 450 one or more notification are provided to the user via the user device 25. Notifications may include, but not be limited to an acknowledgement of the request for services, a notification that the services have been ordered, a time that the services are expected to be available, a notification that the services are ready and available, billing or receipt information, and the like.

The technical effects and benefits of embodiments relate to a method and system for applying user preferences to request and receive services in a building system 20. In one instance the building system 20 may be a hotel where the user is a guest. In addition, the user has a smart device, e.g., mobile phone, has an app operating for interfacing to one or more systems in the hotel for example lock access. For example an app associated with verifying the user and enabling access to the hospitality space. In operation, as part of the user attempting to gain entry to a secured space in the hotel, the mobile device is authenticated by a hotel credentialing app and/or cloud environment. In addition, such enablement also includes an enabling of thermostat control in the hotel space. The enablement may typically be for a selected duration such as from check-in to check-out. Connectivity is either through cloud or peer-to-peer. As soon as the hotel app 29 senses the door lock, it can trigger the synchronizing or downloading the latest user preferences should the user request services. When the app 29 senses that it is no longer in the room or the itinerary indicates as such or the user checks out, the preferences may be deactivated for this particular hotel but ready to be applied to their next hotel stay. Advantageously these features will attract the customers towards specific hotels and facilities where these features are available, thus fostering brand loyalty. Customers are normally interested to configure his/her own preferences and prefer to stay in hotel rooms for which they have the app and user preferences can be defined. Moreover, by employing predictive analysis to the requests for hotel services associated with the customer preferences a given building system 20, e.g., hotel may improve efficiency and provide more effective hotel management services by properly dedicating resources to the services as requested.

The terminology used herein is for the purpose of describing particular embodiments only and is not intended to be limiting of scope and breadth of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the described embodiments in the form disclosed. Many modifications and variations will be apparent to those of ordinary skill in the art without departing from the scope and spirit of the claims. The embodiments have been chosen and described in order to best explain the principles of the inventive concept and the practical application, and to enable others of ordinary skill in the art to understand the scope and breadth of the claims and the various embodiments with various modifications as are suited to the particular use contemplated.

What is claimed is:

1. A method of applying a user preference for a requested service in a building space comprising:
assigning at least one user preference associated with a desired service to a unique identifier;
transmitting the at least one user preference to at least one of a controller associated with a building system and a cloud computing environment associated with the building system;
generating a services request, the services request generated by a user indicating a desire to request the service associated with the unique identifier; and
initiating the services requested based on the at least one user preference associated with the unique identifier.

2. The method of claim 1, wherein the assigning includes executing an app on the user device configured to permit a user to preselect the desired services and assign the desired services to the unique identifier.

3. The method of claim 1, wherein the assigning is independent of location and the building system.

4. The method of claim 1, wherein the transmitting includes communicating the user preferences to at least one of a cloud computing environment associated with the building system, a control device associated with the building system, and an application associated with the building system executing on the user device.

5. The method of claim 1, wherein the user preferences include at least one of a user setting, a schedule, and building system operational parameters.

6. The method of claim 1, wherein the generating includes tapping the user device to a communication device in the building system and the user device communicating with at least one of a cloud computing environment associated with the building system and a control device associated with the building system, the communicating including the unique identifier and information associated with the building space in the building system, and wherein the building system employs the unique identifier to identify the desired services associated therewith.

7. The method of claim 6, wherein the information includes the identifier for the building space in the building system that enables the building system to identify at least one of the requestor of the desired services, the room or location of the building space in the building system, and the current location of the user.

8. The method of claim 1, wherein the initiating includes at least one of a cloud computing environment associated with the building system and a control device associated with the building system employing the unique identifier and information associated with the building space in the building system to identify the desired services associated therewith and request the desired services.

9. The method of claim 1, wherein the building space is a hotel and the desired services include at least one of calling a taxi, a do not disturb notice, check out assistance, room service, and telephone service.

10. The method of claim 1, further including providing a notification to the user via the user device regarding the requested services.

11. The method of claim 1, wherein generating includes presenting a credential for authentication.

12. The method of claim 11, wherein the credential includes at least one of an identification of the user, an identification of a user device, an identification of the control device associated with the first building system, a biometric, and a password.

13. The method of claim 11, wherein the initiating further includes at least one of a cloud computing environment and a control device associated with the building system authenticating the credential and communicating an indicia of authentication to the user device.

14. The method of claim 13, wherein the indicia of authentication is at least one of a message, a token, a digital certificate, and a password.

15. The method of claim 13, wherein the authenticating includes validating a biometric.

16. The method of claim 1, wherein the cloud computing environment and controller associated with the second building system includes a local server.

17. The method of claim 1, wherein the building system is at least one of a security system, access control system, and a vehicle and the control device is a lock.

18. A system for applying a user preference for requested services in a building system, the system comprising:
a building system having a building space associated therewith, the building system includes at least one of a controller associated with the building system and a cloud computing environment associated with the building system, the building system configured to provide an application operable on a user device to facilitate assigning of at least one user preference associated with a desired service associated with the building system to a unique identifier, the user device configured for operable communication with the at least one of the controller associated with the building system and the cloud computing environment associated with the building system, the user device executing an application;
at least one communication device in operable communication with the user device, the at least one communication device providing the unique identifier to the user device and the user device configured to communicate a request for desired services to the at least one of the controller associated with the building system and the cloud computing environment associated with the building system; and
wherein the at least one of a controller associated with the building system and the cloud computing environment associated with the building system are configured to initiate the services requested based on the at least one user preference associated with the unique identifier.

19. A system for applying a user preference for requested services in a building system having a building space associated therewith, the system comprising:
means for assigning at least one user preference associated with a desired service to a unique identifier;
means for configuring a user device to transmit the at least one user preference to at least one of a controller associated with a building system and a cloud computing environment associated with the building system;
means for generating a services request, the services request generated by a user indicating a desire to request the service associated with the unique identifier; and
means for initiating the services requested based on the at least one user preference associated with the unique identifier.
